(19) United States
(12) Patent Application Publication
(10) Pub. No.: US 2005/0040618 A1
(43) Pub. Date: Feb. 24, 2005

(54) Multi-purpose quad-dolly hand truck transporter

(76) Inventor: Linda M. Beatty, Maryville, IN (US)

Correspondence Address: Linda M. Beatty;c/o American Business Centers, 309 Ellis Ave., Maryville, IN, 37801, US

(21) Appl. No.: 10/923,625

(22) Filed: Aug. 21, 2004

Related U.S. Application Data
(60) Provisional application No. 60/497,016, filed on Aug. 22, 2003.

(51) Int. Cl. B62B 3/00

(52) U.S. Cl. 280/79.3

(57) ABSTRACT

A hand truck or dolly for transporting panels, doors, windows, sheetrock, folding tables, mattresses or the like. The hand truck has a base connected to at least four wheels arranged to balance cargo in transport and unloading. A distinguishing feature of the hand truck is a duel cargo holder that allows for circular or small items to be transported at same time as larger items. Invention comprises of a frame having an upper and lower portion supported by a plurality of wheels. Directional movement is accomplished by handle. Strength and balance of the invention exceed that of prior art.

### CROSS-REFERENCE TO RELATED APPLICATIONS

This application is a Continuation of Provisional Patent Application No. 60/497,016 file date Aug. 22, 2003; Confirmation no. 8161

### FEDERALLY SPONSORED RESEARCH

Not Applicable

### BACKGROUND

1. Field of Invention

This invention relates to hand truck transporters and dollies used for transporting doors, windows, lumber, sheetrock, panels and similar cargo.

2. Description of Prior Art

Warehouses, lumber yards, building and supply stores, home decor stores have a Similar challenge of loading and transporting cargo and materials in confined areas congested with people and products. Safety consideration should be employed for humans as well as cargo protection from damage during loading, unloading and transporting cargo.

Originally these hand trucks were built for limited cargo size and weight, as are some today. U.S. Pat. No. 1,193,729 to Stebler (1916) discloses a complex system with many individual small mountings and configurations. Several types of hand truck apparatuses have been proposed over the years—for example, in U.S. Pat. No. 4,752,173 to Fleming (1988) and U.S. Pat. No. 6394,470 (2002 to Shirai and U.S. Pat. No. 4,726,602 (1988) to Sanders.

As seen in the above patents, dollies and hand truck transporters can be heavy, awkward, and often require a second person to assist in loading, unloading and transporting. A desirable objective for hand trucks and dollies is ease in stack ability, non-slip resilient control of cargo, move forward, backward and turn with ease.

Strength and design are required to maintain balance while manipulating a load of cargo. U.S. Pat. No. 5,120,072 to Laramie (1992) discloses a kickstand to lock the frame and said kickstand is used to stabilize such cargo as plasterboard, doors, panels and the like.

The ability to push or pull the dolly forward or backward in circumstances requiring close quarter contact and to load effortlessly unlike the limitability as in U.S. Pat. No. 6,425,724 to Williamson (2002) is a time-saving asset. Building sheet materials can be awkward to load, move and unload. U.S. Pat. No. 3,841,651 (1974) discloses a wheel mounted support platform hand truck for elongated cargo; however, cargo could be easily damaged.

Capacity limitation reduces the effectiveness of U.S. Pat. No. 6,250,655 to Sheeks (2001). U.S. Pat. No. 6,039,332 to Austin discloses maneuverability but with the necessity of a motor. Hand trucks that can be constructed of high impact metal or plastic that requires little maintenance with a long useful life, and that can be mass produced to be cost effective from a consumer and manufacturer's point of view is an objective that some of the above patents lack. Simplicity over complexity is desirable by reducing the number of members, extensions, wheels and platforms as presented in above patents.

In conclusion, insofar as I am aware, no hand truck or dolly formerly developed provides such multi-purpose transportability, duel cargo capabilities, strength, and balance as follows in summary.

### SUMMARY

In accordance with the present invention—the invention, an improved multi-purpose, moveable apparatus (henceforth quad-dolly) designed to accept and transport longitudinal and horizontal objects such as conference tables, plasterboard, doors, panels or the like; having a unique additional structure cargo support plate like member for maintaining circular buckets, tools, or other loose items in an erect and open condition.

Said invention, a plane design composed of four points bounded by two perpendicular radii and they are subtended. Said invention comprising of a frame having an upper porting, a lower portion, and a duel cargo support sheet attached to lower portion of the frame located adjacent to the rear of nose plate (lip). Said frame is supported by a plurality of wheels on one end for ground contact and a handle on the opposite end for directional move ability.

Said invention is composed of structural material such as a metal type substance or a high impact plastic substance, lightweight, good mobility with minimal human strength needed to move said invention loaded with cargo. Cargo stacks easily on non-slip resilient duel cargo unit. Said invention posses both strength and balance while manipulating cargo and is easily maneuvered through congested areas. Said invention eliminates lifting of materials, supports loads on swivel wheels and has a padded material rest to protect contact of cargo with top support of said invention.

Manufacturing of said invention is cost efficient due to the reduced number of members and extensions. There are certain ramifications to said invention for cost-effective distribution that are being explored.

### OBJECTS AND ADVANTAGES

Accordingly, besides the objects and advantages of said multi-purpose dolly designed to transport with ease and be multi-tasked described in my above patent, several objects and advantages of the present invention are:

(a) balance of cargo allows ease of movement of cargo

(b) the unobvious balance of a heavy load maneuvered with little effort

(c) usefulness in the purpose of a dual cargo unit

(d) significant improvement in strength and capability of unloading

(e) slight change in shape produces the unique balance effect

(f) proven commercial success in major warehouses and stores

(g) cost effective to build, transport, and markets

(h) eliminates lifting of materials

(i) supports loads on the four swivel wheels

(j) padded material rest to protect finish

(k) 360 degree swivel wheels with locking rear standard

### DRAWING FIGURES

FIG. 1 is a perspective view of a portable multi-purpose hand truck dolly exposing Lower base with nose plate for supporting horizontal and vertical Cargo, with lower cargo plate for circular and loose items, base-containing wheels for ground contact. Opposite end of ground contact base is padded support top used to sustain and brace cargo.

FIG. 2 is perspective back view of said invention with connecting members, exposing frame and four wheels making ground contact; and opposite ground contact is the section of said invention exposing backside of front padded support member containing handle.

FIG. 3 is base of said invention from bottom perspective exposing mesh plate in relation to connecting members. Extension of cargo lip is visible with connected members.

### REFERENCE NUMERALS IN DRAWINGS

| | |
|---|---|
| 6 handle | 8 top support |
| 20 carriage bolts | 21 lock nuts |
| 12 frame | 32 wheels |
| 34 coaster | 30 nose plate lip |
| 36 front angle iron | 14 top cross member |
| 22 bottom cross member | 26 back pipe rail |
| 28 back angel iron | 35 mesh bottom |

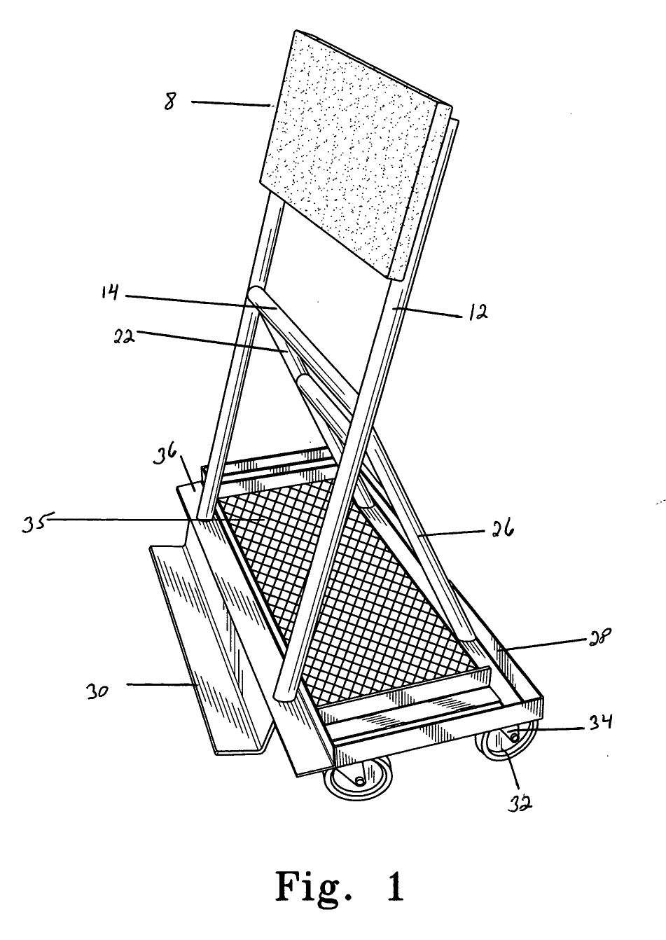

### Description—FIG. 1

A hand truck having a ground engaging members 32 are secured to the frame of Said hand truck by angle arm supports 28 ground engaging member 32 supported by member 34. Ground engaging members 32 assumes the entire weight of the loaded hand truck. Member 30 nose plate lip supports cargo, member 35 supports circular and miscellaneous cargo. Member 12 upper frame support and member 26 lower frame support creates the unique balance of cargo as member 30 not only supports cargo but balances cargo as hand truck frame is forced forward to unload. Member 14 purpose is top cross support for frame. Member 22 bottom cross member for support. Member 36 Front angle iron for base support. Member 8 top support can be bolted or glued with soft Material to protect sensitive cargo.

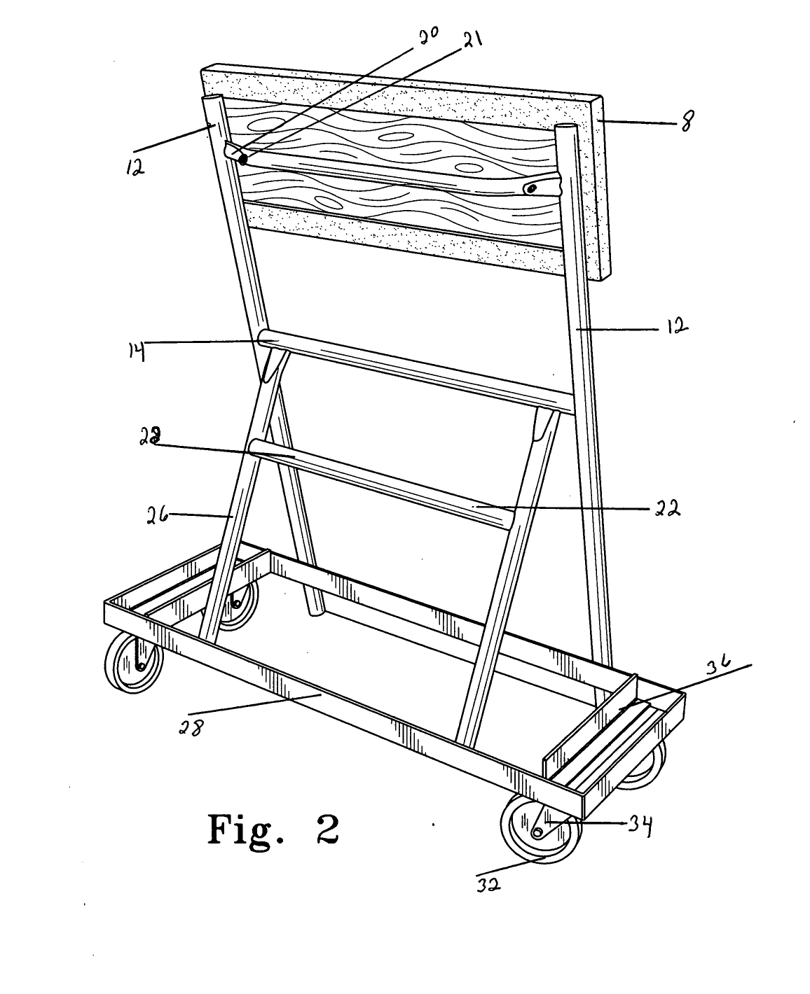

### Description FIG. 2

Member 28 defines base support structure with members 32 ground engaging members connected by member 34 coasters. Member 26 lower frame support connected to member 14 top cross member by welding or bolting. Member 14 connected to member 12 top frame support and member 26 lower frame support. Member 8 connected to member 12 top frame. Member 6 is used to maneuver truck dolly centered between member 12 right and left side bolted in place with members 20 and 21. Member 36 angle iron support base.

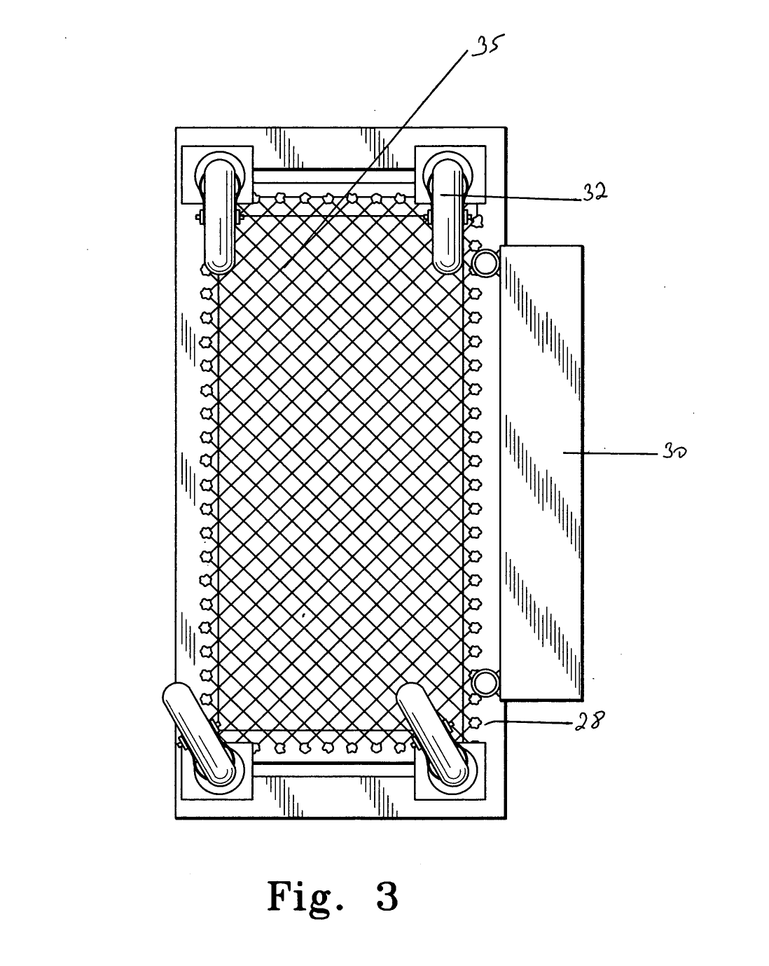

### Description FIG. 3

Bottom Perspective member 28 base support, member 32 ground engaging member. Member 35 mesh bottom for circular and miscellaneous cargo connected to Member 30 nose plate lip. Member 30 view of lower base lip with connected members for bearing weight of cargo. All members can be secured by bolts or welding of materials determined by material used to construct said hand truck.

1. I claim a multi-purpose quad dolly hand truck transporter comprising of
First and second support frames, each of said frames including an upwardly and lower slanted extension connecting to ground base support. Ground base support either mesh or solid plate formation. The bottom support base connected with the rear support member and the base support member, and a bottom support brace connected with the bottom support member and the base support member. The bottom support member also being connected with one of the rear support members also being connected with one of the bottom support members and the base support member.
A nose plate received adjacent the bottom support member and being forwardly slanted, as retaining means for retaining said plate adjacent the bottom support member
At least four wheels attached to said bottom side, at least two of said wheels having axes of their rotation fixed with respect to said base; at least one of said wheels being supported on an axel which can swivel in a horizontal plane with respect to said base, all of said wheels being arranged in the same plane which coincides with the longitudinal axis of said base.
Said vertical frame comprising of at least two vertical stands inter connected by at least one cross bar; said stands being additionally attached to said base which imparts greater rigidity to said frame.
Opposite ground contact base structure protrudes padded support structure with opposite side of padded structure containing a longitudinally elongated handle.
Said invention is constructed of suitable materials of sufficient size and strength to accommodate duel cargo.
